(19) United States
(12) Patent Application Publication
(10) Pub. No.: US 2017/0332561 A1
(43) Pub. Date: Nov. 23, 2017

(54) Garden Spring

(71) Applicant: Jeff Martin, Cynthiana (US)

(72) Inventor: Jeff Martin, Cynthiana (US)

(21) Appl. No.: 15/160,457

(22) Filed: May 20, 2016

(51) Int. Cl. A01G 9/12; A01G 27/00; A01G 9/02

(52) U.S. Cl. CPC A01G 9/12; A01G 9/02; A01G 27/006

(57) ABSTRACT

A garden spring for supporting climbing plants, including a hollow pipe configured in a serpentine spiral between a first end and a second end, an anchor section at the second end of the pipe, and a fluid intake at the first end of the pipe, wherein the fluid intake is in fluid communication with an interior volume of the pipe.

### FIELD OF THE INVENTION

The present invention relates to gardening and more particularly to a method and apparatus for growing climber plants.

### BACKGROUND OF THE INVENTION

In some areas, especially urban areas, gardening space is limited. Climbing plants typically grow upward, rather than sprawling across the ground. Therefore, climbing plants may be preferable in gardens having small area.

### SUMMARY OF THE INVENTION

Embodiments of the present invention relate to a garden spring for supporting climbing plants, including a hollow pipe configured in a serpentine spiral between a first end and a second end, an anchor section at the second end of the pipe, and a fluid intake at the first end of the pipe, wherein the fluid intake is in fluid communication with an interior volume of the pipe.

Further embodiments of the present invention include a kit for assembling a garden spring for supporting climbing plants, including a plurality of interlocking pipe sections including a first interlocking pipe section including a first end comprising a first connector, a second end comprising a second connector, and a first interior volume extending through the first connector, the second connector, and a length of the first interlocking pipe section, wherein the first connector is sized to fictionally fit with the second connector, and wherein the plurality of interlocking pipe sections are configured for the assembly of a pipe comprising a serpentine spiral shape from a first end of the pipe to a second end of the pipe.

Additional embodiments include a kit for assembling a garden spring for supporting climbing plants, including a bucket, a hollow pipe configured in a serpentine spiral between a first end and a second end, including an anchor section at the second end of the pipe, and a fluid intake at the first end of the pipe, wherein the fluid intake is in fluid communication with an interior volume of the pipe, and wherein the hollow pipe is collapsible such that the entire hollow pipe is contained within the bucket.

### BRIEF DESCRIPTION OF THE DRAWINGS

FIG. 1 depicts a diagram of a side view of the garden spring partially positioned within a bucket, in accordance with the principles of the present invention.

FIG. 2 depicts a diagram of a side view of the garden spring of FIG. 1 comprising a fluid intake in accordance with the principles of the present invention.

FIG. 3 depicts a diagram of the garden spring of FIG. 2 wherein the anchor section comprises drip line.

FIG. 4 depicts a diagram of an alternative fluid intake in accordance with the principles of the present invention.

FIG. 5 depicts a diagram of a top-down view of the garden spring of FIG. 3.

FIG. 6 depicts a diagram of a top-down view of another alternative fluid intake positioned on the garden spring in accordance with the principles of the present invention.

FIG. 7a depicts segmented pipe sections of a garden spring in accordance with the principles of the present invention.

FIG. 7b depicts the attachment of segmented pipe sections of a garden spring in accordance with the principles of the present invention.

### DETAILED DESCRIPTION OF THE PREFERRED EMBODIMENTS

“About,” as used in this application, means within plus or minus one at the last reported digit. For example, about 1.00 means 1.00±0.01 unit.

“Around,” when used to describe a unit or percentage, means within plus or minus one unit or plus or minus one percentage point.

“Substantially,” as used in this application with reference to an angle, means within one degree. For example, substantially planar means within one degree counterclockwise and within one degree clockwise of planar orientation.

“Substantially similar,” as used in this application, means having at least each of the properties of the referenced structure plus the additional structure disclosed. If the additional structure conflicts, the additional structure supersedes the structure incorporated by reference.

For the purposes of this disclosure, “and” and “or” shall be construed as conjunctively or disjunctively, whichever provides the broadest disclosure in each instance of use of “and” and “or.”

For the purposes of this disclosure, structures disclosed in singular form are not limited to a single structure, but can include multiple instances of the disclosed structure, unless specifically stated otherwise.

The detailed description set forth below in connection with the appended drawings is intended as a description of various embodiments of the invention and is not intended to represent the only embodiments in which the invention may be practiced.

The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

In some areas, especially urban areas, gardening space is limited. Climbing plants typically grow upward, rather than sprawling across the ground. Therefore, climbing plants may be preferable in gardens having small area. However, support structures aid the growth of climbing plants. A garden spring can be used as a support structure for climbing plants. The garden spring can be used with pole beans, climbing vines, tomatoes, cucurbits, cucumbers, melons, squashes, pumpkins, gourds, zucchini, sweet potatoes, etc.

The garden spring of the present invention may be sold as a single unit. Embodiments also include selling the garden spring as a kit for later assembly.

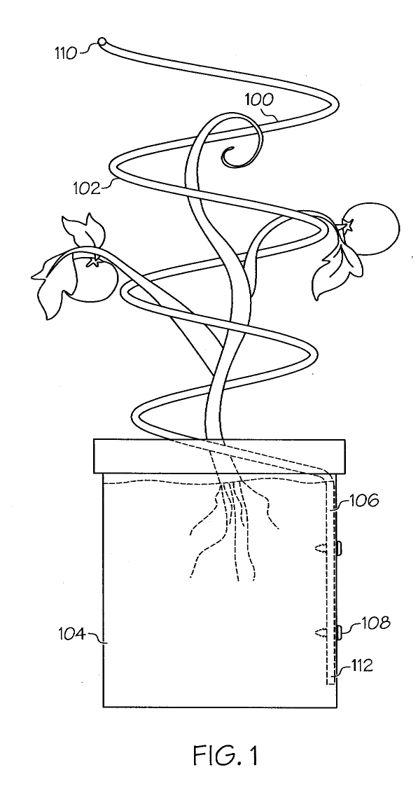

FIG. 1 depicts a diagram of a side view of the garden spring 100 partially positioned within a bucket, in accordance with the principles of the present invention Garden spring 100 may comprise a pipe 102. Pipe 102 may have a diameter of about 0.3 cm. In other embodiments, the pipe 102 may have a diameter of about 1.3 cm. Therefore, the pipe 102 may be capable of storing about 1.7 liters within the pipe 102. Thus, the volume of the pipe 102 may be about 1.7 liters. The pipe 102 may be about 305 cm long. Pipe 102 may comprise a first end 110 extending to a second end 112. Pipe 102 may comprise a serpentine spiral, wherein the serpentine spiral may be a conical spiral, a cylindrical spiral, a square spiral, a triangular spiral, a rectangular spiral, or any other spiral shape.

Pipe 102 may comprise any material sufficiently rigid to support the weight of the pipe 102 when the pipe 102 is filled with water and of a climbing plant hanging from the pipe 102. Example materials include metals, such as aluminum or steel, plastics, composites, etc. In some embodiments, the pipe 102 may be rigid such that the serpentine shape is retained under pressure. Alternate embodiments include the pipe 102 having a flexible rigidity such that a person can manipulate the shape and position of the pipe 102. Thus, the serpentine spiral of the spring 100 may have a low absolute spring constant value, such that the length of the serpentine spiral is alterable by pushing or pulling the first end and the second end together or apart, respectively. Furthermore, the material may retain the altered length of the serpentine spiral.

By way of example, the outer diameter of the serpentine spiral may be less than the inner diameter of a bucket 104. In this manner, the pipe 102 may be positioned within the bucket 104 at the point of sale. Thereafter, the purchaser may extend the pipe 102 outside the bucket 104.

For example, the bucket 104 may be a standard five gallon bucket. Standard five gallon buckets are made of high density polyethylene. Standard five gallon buckets are slightly tapered so you can stack them and they are easy to separate. Some five gallon buckets have a sturdy wire bail with a plastic handgrip. Standard five gallon bucket measurements are as follows, 30.3 cm diameter×36.8 cm high×26.2″ diameter at the bottom. The wall thickness of a standard five gallon bucket is 0.075″+/−0.005″. In some embodiments, the pipe 102 may comprise flexible materials such that the pipe 102 may be collapsible such that the pipe 102 fits within the bucket.

In some embodiments, the pipe 102 may have a roughened surface such that plants can grip onto the pipe 102. For example, the roughened surface may be formed by tempering the pipe 102 at less than galvanization temperature. Thereafter, standard power coating techniques for painting the pipe 102 may cause small protrusions that enable climbing plants to grip the pipe 102.

The second end 112 of the pipe 102 may comprise an anchor section 106. The anchor section 106 may comprise one or more anchors 108. Anchors 108 may extend through the anchor section 106 of the pipe 102 and through a side of the bucket 104. However, the anchors 108 can include any attachment mechanism between the bucket and the anchor section 106. Example anchors 108 can include cotter pins, bolts, nails, screws, brads, adhesives, etc. The anchor section 106 may comprise drip line, such that water can be added within pipe 102 and may be dripped out the drip line.

The bucket 104 may comprise any material sufficient for containing dirt and at least one plant and sufficient to support an anchored pipe 102. Example materials include wood, one or more plastics, one or more composites, one or more metals, etc.

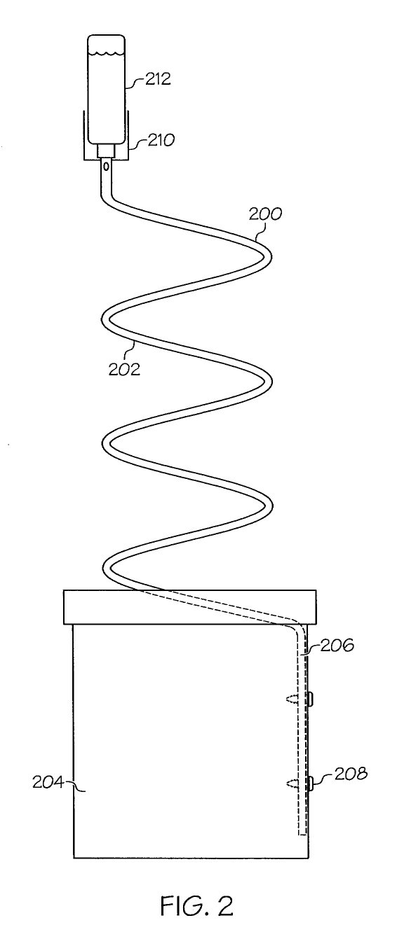

FIG. 2 depicts a diagram of a side view of a garden spring 200 that is substantially similar to the garden spring 100 of FIG. 1. The garden spring 200 may further comprise a fluid intake 210 in accordance with the principles of the present invention. The fluid intake 210 may be in fluid communication with the drip line of the anchor section 206 through the pipe 202. In some embodiments, the fluid intake 201 may comprise a garden bib.

Fluid intake 210 may comprise a valve for regulating the flow of water. For example, a ball valve, butterfly valve, globe valve, gate valve, diaphragm valve, etc. may be used. The valve may be positioned between the fluid intake 210 and the pipe 102 such that the flow of liquid from the fluid intake 210 to the pipe 102 may be controlled by a control mechanism of the valve. However, some embodiments of the fluid intake 210 do not necessarily comprise a valve. In these embodiments, the fluid may be restricted by the diameter of the fluid intake 210, a source of fluid to the fluid intake 210, and/or another restrictive structure, such as a hole in a bottle cap wherein a bottle has been place upside down in the fluid intake 210.

The fluid intake 210 may comprise a receptacle for receiving fluids, such as water, liquid fertilizer, etc. Additionally, the fluid intake 210 can comprise a bird bath or water basin. Such a fluid intake 210 may also be decorative, such as resembling a flower. Alternate fluid intakes 210 may receive a structure for providing water, such as a water bottle or a water hose. In some embodiments, the fluid intake 210 may be sized to frictionally fit a water bottle 212 with a hole poked into the cap. A standard water bottle, which may be frictionally fit to within the fluid intake 210, can be 73 mm in diameter and 127 mm tall. Other embodiments of the fluid intake 210 may be threaded to receive the end of a water hose. The fluid intake 210 may comprise sufficient materials to support and retain water or to support the structure for providing water.

The pipe 202 may be substantially similar to the pipe 102. The anchor section 206 may be substantially similar to the anchor section 106. The anchors 208 may be substantially similar to the anchors 108. The bucket 204 may be substantially similar to the bucket 104.

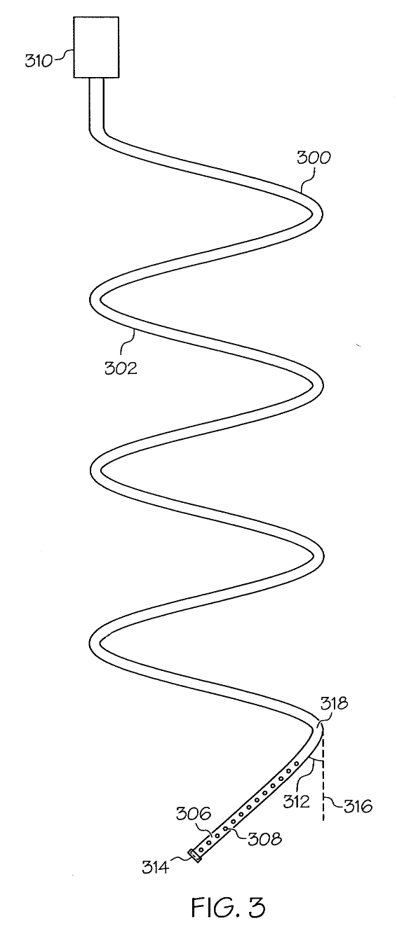

FIG. 3 depicts a diagram of a garden spring 300 that is substantially similar to the garden spring 200 of FIG. 2 wherein the anchor section 306 comprises a drip line. Thus, the anchor section 306 may comprise holes 308 sized to allow water to drip from the interior of anchor section 306 to the inside of the bucket, such as bucket 204. In some embodiments, part or all of the pipe 302 may also comprise drip line. In these embodiments, the holes 308 may be positioned on the pipe 302 above the bucket, such as bucket 204.

As depicted in FIGS. 1 and 2, the anchor section 106, 206, may be angled at a 0 degree anchor angle 312 relative to a parallel tangent 316 at a transition section 318, wherein the parallel tangent 316 is parallel to a central axis of the spiral. In some embodiments, the transition section may comprise an area of the hollow pipe between the serpentine spiral and the anchor section. In some embodiments, the anchor section is straight and does not necessarily continue in the serpentine spiral shape. Thus, embodiments having a 0 degree anchor angle 312 may allow for attachment of the anchor section 106, 206, 306 to the side of a bucket 204. In some embodiments, the anchor section 106, 206, and 306 may be angled at a 45 degree anchor angle 312 relative to the parallel tangent. In other embodiments, the anchor angle 312 may be between 55 and 60 degrees, inclusive. The anchor angle 312 may be determined by a parallel tangent 316 parallel to the central axis of the serpentine spiral, wherein the parallel tangent 316 is tangent to the outside of the pipe 302. One benefit of the anchor angle 312 being 45 degrees or greater is that it reduces the likelihood of the garden spring 300 spinning when buried in the ground.

The garden spring 300 may also comprise a cap 314 sized to frictionally fit to the second end of the pipe 302. The cap 314 may prevent dirt from entering the pipe 302 as the pipe 302 is inserted into the ground or dirt-containing bucket. In some embodiments, the entire anchor section 306 may be inserted into the ground or dirt.

The pipe 302 may be substantially similar to the pipe 102. The anchor section 306 may be substantially similar to the anchor section 106. The garden spring 300 may also comprise a fluid intake 310 that may be substantially similar to fluid intake 210.

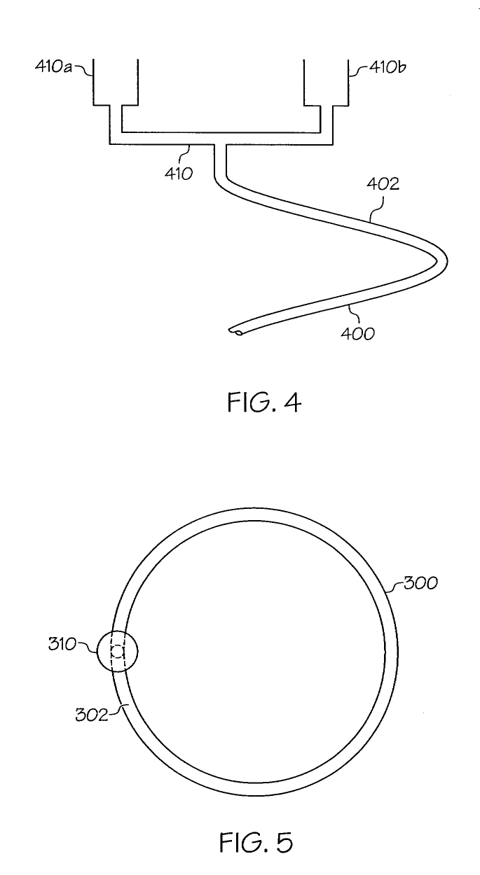

FIG. 4 depicts a diagram of an alternative fluid intake 410 in accordance with the principles of the present invention. Fluid intake 410 may be substantially similar to fluid intake 310. Furthermore, fluid intake 410 may comprise multiple fluid intakes 410a and 410b. The pipe 402 may be positioned such that fluid intakes 410a and 410b are in fluid communication with pipe 402. Thus, the contents of the fluid intakes 410a and 410b may be combined. For example, liquid fertilizer may be fed into pipe 402 from fluid intake 410a at the same time as water is fed into pipe 402 from fluid intake 410b.

Garden spring 400 may be substantially similar to garden spring 300. Pipe 402 may be substantially similar to pipe 302. Fluid intake 410a may be substantially similar to fluid intake 310. Fluid intake 410b may be substantially similar to fluid intake 310.

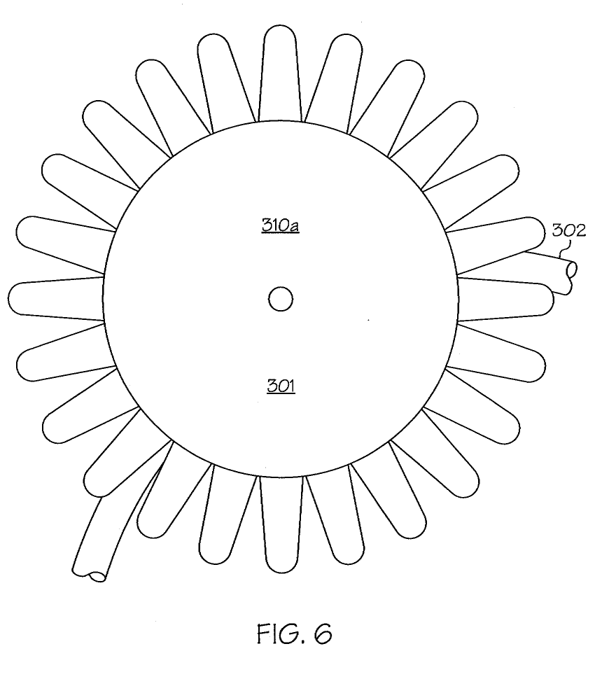

FIG. 5 depicts a diagram of a top-down view of the garden spring of FIG. 3. In this depiction, garden spring 300 may comprise pipe 302 shaped in a cylindrical spiral. Furthermore, fluid intake 310 may be positioned atop pipe 302. The operation of gravity may pull water from fluid intake 310 into pipe 302. In some embodiments, pipe 302 may be bent such that the fluid intake 310 may be within the spiral or outside the spiral of the pipe 302.

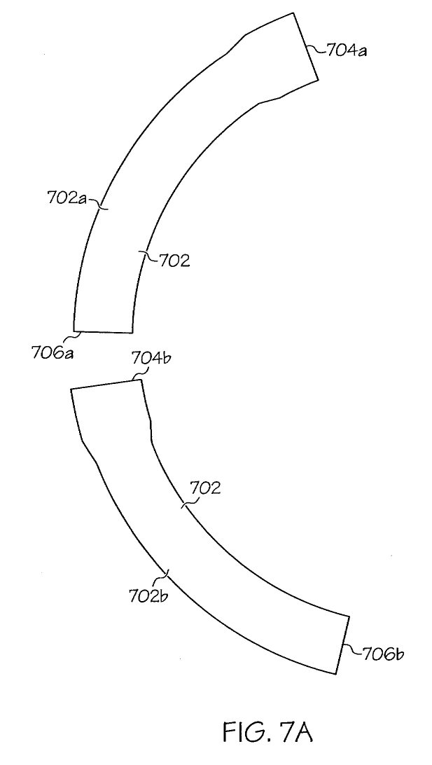

FIG. 6 depicts a diagram of a top-down view of another alternative fluid intake 310a positioned on the garden spring 300 in accordance with the principles of the present invention. In this embodiment, the fluid intake 310a may be configured to resemble a flower. Furthermore, the fluid intake 310a may be sized to resemble a bird bath. In some embodiments, the fluid intake 310a resembles a bird bath bowl 301, wherein the bird bath bowl 301 is sized hold a volume of water sufficient for a songbird, such as a robin, to bathe in the bowl 301.

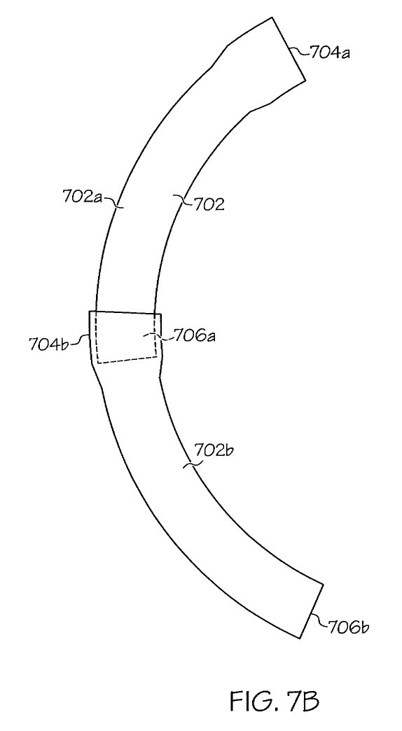

FIG. 7a depicts segmented pipe sections 702a, 702b of a pipe 702 in accordance with the principles of the present invention. The pipe may be substantially similar in all respects to the pipe 302. However, the pipe 702 may be separated into pipe sections 702a, 702b. The pipe sections 702a, 702b may be configured to frictionally fit a corresponding pipe section 702a, 702b. For example, a first end 704a, 704b may comprise a dilated connector section to receive a second end 706a, 706b. In some embodiments, second end 706a, 706b may comprise a tapered connector section to fit within 704a, 704b. Additionally, the fluid intake 210, 310, 410a, 410b may comprise a dilated and/or tapered connector section sized to frictionally fit with the first end 704a, 704b, and/or the second end 706a, 706b. Furthermore, anchor section 106, 206, 306 may comprise a dilated and/or tapered connector section sized to frictionally fit with the first end 704a, 704b, and/or the second end 706a, 706b.

FIG. 7b depicts the attachment of the segmented pipe sections 702a, 702b of the garden spring in accordance with the principles of the present invention. In this example, the second end 706a of the first pipe section 702a may be frictionally fit within the dilated first end 704b of the second pipe section 702b. In this manner, many pipe sections similar to 702a and 702b may be fit together to comprise the entire pipe 702. Therefore, pipe 702 may be substantially similar to pipe 302, 202, or 102.

Furthermore, the pipe sections 702a, 702b may be separated and positioned within the bucket, such as bucket 204. Furthermore, the fluid intake 210, 310, 410a, 410b may also be placed in the bucket, such as bucket 204. Additionally, the anchor section 106, 206, 306 may be placed in the bucket. In this manner, the volume of a kit for constructing the garden spring may be reduced, such as at the point of sale. Minimal volume may be desired when positioned in storage, such as in a warehouse or a storeroom. After purchase or for display, the pipe sections 702a, 702b may be removed from the bucket and constructed into pipe 702, such as via frictional fit of connector sections of respective pipe sections 702a, 702b. Furthermore, the anchor section 106, 206, 306 may be frictionally fit to an end of the constructed pipe 702 and anchored to a bucket, such as bucket 204. Additionally, the fluid intake 210, 310, 410a, 410b may be frictionally fit to an end of the constructed pipe 702, such that the fluid intake 210, 310, 410a, 410b is in fluid communication with an interior volume of the constructed pipe 702.

Additionally, the cross-section of the pipe sections 702a, 702b may be circular. However, embodiments having a non-circular cross-section of the pipe sections 702a, 702b may be such that the pipe sections 702a, 702b do not rotate relative to a connected pipe section 702a, 702b. Example non-circular cross-sections can include, triangular, rectangular, elliptical, hexagonal, etc.

An example kit for building the garden spring may include one or more of a pipe, such as pipe 102, 202, 302, 702, pipe sections, such as pipe sections 702a, 702b, a bucket, such as bucket 104, 204, a fluid intake, such as fluid intake 210, 310, 410, 410a, 410b, an anchor section, such as anchor section 106, 206, 306, a cap 314, one or more anchors 108, 208, dirt, one or more plant seeds, one or more plant seedlings, one or more plants, water, solid and/or liquid fertilizer, and/or a bucket lid. The plant seeds, plant seedlings, or plants may be that of any of pole beans, climbing vines, tomatoes, cucurbits, cucumbers, melons, squashes, pumpkins, gourds, zucchini, sweet potatoes, flowers, etc. Based on this description, any of the disclosed elements may be selected to form the kit for constructing the garden spring.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with each claim's language, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.

What is claimed is:

1. A garden spring for supporting climbing plants, comprising:
a hollow pipe configured in a serpentine spiral between a first end and a second end;
an anchor section at the second end of the pipe; and
a fluid intake at the first end of the pipe,
wherein the fluid intake is in fluid communication with an interior volume of the pipe.

2. The garden spring of claim 1, wherein the fluid intake comprises a bird bath bowl.

3. The garden spring of claim 1, further comprising a valve positioned to regulate the flow of liquid from the fluid intake to the interior volume of the pipe.

4. The garden spring of claim 1, wherein the anchor section comprises one or more drip line holes.

5. The garden spring of claim 1, wherein the pipe comprises one or more drip line holes.

6. The garden spring of claim 1, wherein the interior volume of the pipe is about 1.7 liters.

7. The garden spring of claim 1, wherein an anchor angle of the pipe is about 0 degrees relative to a parallel tangent.

8. The garden spring of claim 1, wherein an anchor angle of the pipe is about 45 degrees relative to a parallel tangent.

9. The garden spring of claim 1, wherein an anchor angle of the pipe is between about 55 to about 60 degrees relative to a parallel tangent.

10. The garden spring of claim 1, wherein the fluid intake comprises a threaded connector configured to receive a threaded connector of a hose.

11. The garden spring of claim 10, wherein the fluid intake comprises a garden bib.

12. The garden spring of claim 1, wherein the fluid intake is configured to receive a water bottle.

13. The garden spring of claim 1, further comprising:
a bucket,
wherein the largest outer diameter of the serpentine spiral of the pipe is less than the inner diameter of the bucket.

14. The garden spring of claim 13, further comprising:
one or more anchors configured to attach the anchor section of the pipe to a side of the bucket.

15. The garden spring of claim 1, wherein the largest outer diameter of the serpentine spiral of the pipe is about 30.3 cm or less.

16. A kit for assembling a garden spring for supporting climbing plants, comprising:
a plurality of interlocking pipe sections comprising a first interlocking pipe section comprising:
a first end comprising a first connector,
a second end comprising a second connector, and
a first interior volume extending through the first connector, the second connector, and a length of the first interlocking pipe section,
wherein the first connector is sized to fictionally fit with the second connector, and
wherein the plurality of interlocking pipe sections are configured for the assembly of a pipe comprising a serpentine spiral shape from a first end of the pipe to a second end of the pipe.

17. The kit of claim 16, further comprising:
a fluid intake that is configured to frictionally fit with at least one of the first connector and the second connector of the first interlocking pipe section.

18. The kit of claim 16, further comprising:
an anchor section comprising an interior volume, wherein the anchor section is configured to frictionally fit with at least one of the first connector and the second connector of the first interlocking pipe section.

19. The kit of claim 18, comprising:
one or more drip line holes extending from the interior volume of the anchor section to an outer surface of the anchor section.

20. A kit for assembling a garden spring for supporting climbing plants, comprising:
a bucket;
a hollow pipe configured in a serpentine spiral between a first end and a second end, comprising:
an anchor section at the second end of the pipe; and
a fluid intake at the first end of the pipe,
wherein the fluid intake is in fluid communication with an interior volume of the pipe, and
wherein the hollow pipe is collapsible such that the entire hollow pipe is containable within the bucket.
